(19) United States
(12) Patent Application Publication
(10) Pub. No.: US 2005/0244655 A1
(43) Pub. Date: Nov. 3, 2005

(54) Thermo-adherent composition for coil wires

(76) Inventors: Jerome Fournier, Lyon (FR); Olivier Pinto, Lyon (FR)

Correspondence Address: SOFER & HAROUN, L.L.P., Suite 910, 317 Madison Avenue, New York, NY, 10017, US

(21) Appl. No.: 11/115,958

(22) Filed: Apr. 26, 2005

(30) Foreign Application Priority Data
May 3, 2004 (FR) 04 04762

(51) Int. Cl. B32B 27/40

(52) U.S. Cl. 428/423.1

(57) ABSTRACT

A thermo-adherent composition for coil wires includes a polyester type thermoplastic polyurethane.

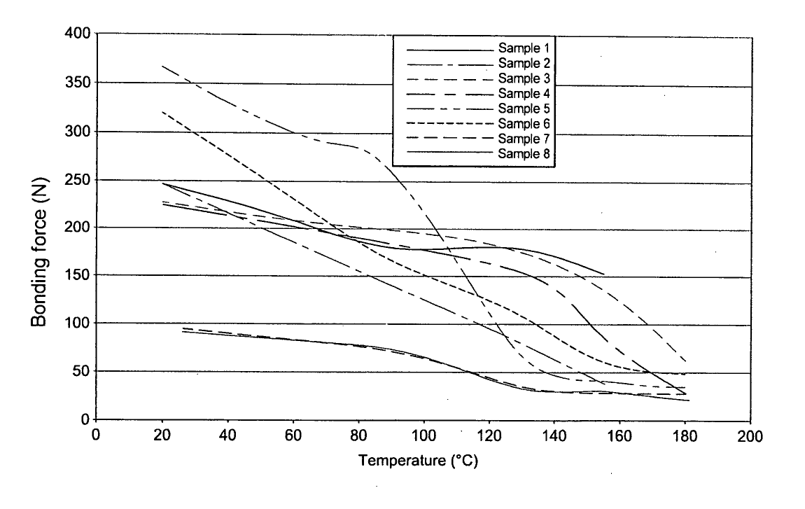

### RELATED APPLICATIONS

This application is related to and claims the benefit of priority from French Patent Application No. 04 04762, filed on May 3, 2004, the entirety of which is incorporated herein by reference.

### BACKGROUND OF THE INVENTION

1. Field of the Invention

The present invention relates to a composition intended to constitute the thermo-adherent layer of a coil wire.

The invention finds a particularly advantageous, although not exclusive, application in the field of electrical machines employing coil wire windings to create magnetic fields.

2. Description of the Prior Art

One currently widespread solution for producing a coil wire consists in covering an insulated conductor with a thermo-adherent external layer of thermoplastic material. The wire prepared in this way can then be wound to form the required final winding. The various turns are then fastened together by heating the coil wire to a temperature equal to or greater than the melting point of the thermoplastic material used. This operation is commonly effected either by means of the Joule effect, by passing a current of appropriate magnitude through the wire, or by direct heating by placing the coil in an oven, for example. In concrete terms, once the thermoplastic material has softened, interpenetration occurs between the respective external layer portions of the directly adjacent turns; obviously, consolidation becomes effective only after the assembly has cooled.

At present, the thermo-adherent layers of coil wires are generally made from thermoplastic materials based on polyamide. Although it has satisfactory thermomechanical properties, this type of material offers cohesion forces that are insufficient for applications in which the insulated coil wire moves, for example in an electric motor rotor, but also for applications in which it is subjected to high temperatures, in particular temperatures exceeding 100° C. In such cases it is often indispensable to add an impregnation varnish to confer good cohesion properties on the coil.

Also, polyamide-based thermoplastic materials have the drawback of being difficult to use in the particular context of the invention.

This is because some polyamides and/or their copolymers need to be dissolved beforehand in an organic solvent in order to be applied to an insulated conductor, in situations where an enameling type process is employed to form the thermo-adherent layer. In practice, the solvents employed commonly belong to the phenol, cresol, hydrocarbon or N-methyl pyrrolidone family. These organic substances are particularly volatile and relatively harmful and are therefore difficult to handle. Also, at the end of the process, complete elimination of the solvent and drying of the thermoplastic material requires heavy plant and considerable energy.

Other polyamides and/or their copolymers have to be heated to very high temperatures to achieve sufficient viscosity for coating in the molten state when a fusion type process is used to form the thermo-adherent layer. Unfortunately, this leads to premature deterioration of the polyamides, with the ultimate consequence of the formation in the thermo-adherent layer of defects that are subsequently liable to compromise the correct functioning of the coil wire.

To overcome the above problems, it is known in the art to use a thermoplastic polyurethane to constitute the thermo-adherent external layer of a coil wire.

U.S. Pat. No. 4,324,837 describes a coil wire made up of an insulated conductor that is covered with a coating whose composition is essentially based on an ether type thermoplastic polyurethane.

However, this type of thermo-adherent composition has the drawback of offering satisfactory performance only within a relatively narrow range of temperatures. This means that when a coil made from this kind of coil wire is subjected to somewhat extreme operating temperatures, the adhesion force between the various turns may prove insufficient to guarantee the structural integrity of said coil and therefore the constancy of the magnetic field that it is to generate.

Thus the technical problem to be solved by the subject matter of the present invention is that of providing a thermo-adherent composition for coil wires that avoids the problems of the prior art by offering significantly improved thermomechanical properties.

### SUMMARY OF THE INVENTION

The solution in accordance with the present invention to the technical problem as stated is that the thermo-adherent composition includes a polyester type thermoplastic polyurethane.

This particular type of thermoplastic has the advantage of offering very good thermomechanical properties, and more particularly a high stiffness over a wide range of temperatures, substantially from room temperature to around 180° C. Polyester type thermoplastic polyurethanes also have extremely low viscosities in the molten state, and in particular at temperatures slightly higher than their melting point, which greatly facilitates their application. This particular type of thermoplastic also proves significantly less costly than the polyamide-based counterparts of the prior art.

According to one feature of the invention, the modulus of conservation of the thermoplastic polyurethane is greater than 1 000 MPa at 25° C. and preferably greater than 2 000 MPa.

It is particularly advantageous if the modulus of conservation of the thermoplastic polyurethane is greater than 500 MPa at 100° C. and preferably greater than 1 000 MPa.

According to another advantageous feature of the invention, the modulus of conservation of the thermoplastic polyurethane is greater than 100 MPa at 150° C. and preferably greater than 200 MPa.

The fact that the elastic modulus of a thermoplastic polyurethane according to the invention remains high over a wide range of temperatures, more particularly above 100° C., means that the cohesion of the thermo-adherent layer remains effective over the whole range of operating temperatures of the coil wire. The modulus of conservation is preferably greater than 2 000 MPa at 25° C., greater than 1 000 MPa at 100° C. and greater than 200 MPa at 150° C.

Note that polyester type thermoplastic polyurethanes generally have moduli of conservation significantly higher than polyether type thermoplastic polyurethanes. This is one reason for which compositions of the invention offer much better thermomechanical properties than prior art polyether-based thermoplastic compositions.

According to another feature of the invention, the bonding temperature of the thermoplastic polyurethane is from 150 to 250° C. and preferably from 150 to 200° C.

This is because it is important for the temperature in the vicinity of which the various portions of the thermo-adherent layer consolidate is neither too high, so as not to necessitate too great a quantity of energy in the fabrication of the coil, and in particular during the operation of bonding the turns, nor too low, in order for the turns not to separate during use of said coil.

It is particularly advantageous if the viscosity of the thermoplastic polyurethane in the molten state is less than 100 Pa·s at 300° C. and preferably less than 1 Pa·s.

During fabrication of a winding from a coil wire, a low viscosity in the molten state increases the interpenetration of the various directly adjacent portions of the thermo-adherent layer and consequently encourages consolidation of the turns.

According to another advantageous feature of the invention, the thermoplastic polyurethane has a crystalline phase.

This feature achieves very clear fusion of the material constituting the thermo-adherent layer, which further facilitates its application to the insulated conductor that is to become a coil wire.

According to another feature of the invention, the thermo-adherent composition includes at least one inorganic charge.

This refers to any prior art charge that can be dispersed in a thermoplastic matrix, for example a charge intended to enhance the mechanical properties of thermoplastic polyurethane, a fireproofing charge, a conductive charge, a charge for coloring the thermo-adherent layer, etc.

According to another feature of the invention, the thermo-adherent composition includes at least one other polymer.

This feature simply means that the material that is to compose the thermo-adherent layer of the coil wire may consist of a mixture of polymers of which at least one is a polyester type thermoplastic polyurethane. For example, it is possible to produce a thermo-adherent layer from a mixture of polyamide and thermoplastic polyurethane.

Of course, the invention also relates to any coil wire including a conductive element inside an insulative element covered by an external thermo-adherent layer based on a thermo-adherent composition as described above.

Other features and advantages of the present invention will appear in the course of the following description of illustrative and non-limiting examples.

### BRIEF DESCRIPTION OF THE DRAWINGS

The sole FIGURE is a temperature versus bonding force chart for eight thermoplastic samples, according to one embodiment of the present invention.

### DETAILED DESCRIPTION OF EXAMPLES

Note that examples I to III relate to coil wires that are typically intended to be wound and consolidated to constitute TV deflection coils, electric motor windings, lighting windings, transformers, etc. It must also be pointed out that the coil wires in question are all provided with a thermo-adherent external layer made from thermoplastic material.

### Example I

Table 1 details the structure of two coil wires A and B which differ only in the nature of their respective thermo-adherent layers. Each wire was an insulated wire of 0.37 mm diameter surrounded by a 10 μm thick thermo-adherent external layer. The wire itself was a conductive copper wire of 0.335 mm diameter that is covered with a 17.5 μm thick layer of insulative varnish.

The wire A constitutes a standard coil wire in the sense that its thermo-adherent layer consists of polyamide, the thermoplastic material most widely used in electromagnetic TV deflection coils.

The wire B is a coil wire of a new type in that its thermo-adherent layer consists of a material of the invention, in this example an Estane X4995 thermoplastic polyurethane from Noveon.

In order to be able to make an objective comparison of the coil wires A and B, the adhesion capabilities of the two types of thermo-adherent layer were determined using a Danske System Electronik DSE-2200 measuring device and the measuring protocol established by that company.

The coil wire of each sample to be tested was first wound onto a metal former. The former was then heated to a temperature of 200° C. for 60 seconds in order to soften the external thermo-adherent layer and thereby allow consolidation of contiguous turns. The assembly was then cooled to room temperature by means of a fan system. The resulting winding was then unwound at increasing temperatures by applying a traction force to the free end of said winding. The necessary force was measured as a function of temperature.

Table 1 below sets out the structure of each coil wire and the results of each test.

TABLE 1

Sample

| | A | B |
|---|---|---|
| Conductive wire diameter (mm) | 0.335 | 0.335 |
| Insulated wire diameter (mm) | 0.370 | 0.370 |
| Coil wire diameter (mm) | 0.390 | 0.390 |
| Nature of thermo-adherent layer | polyamide | TPU Estane |
| | | X4995 |
| Bonding time (s) | 60 | 60 |
| Bonding temperature (° C.) | 200 | 200 |
| Pull-off temperature for a | 108 | 133 |
| force of 1.5 N (° C.) | | |
| Pull-off force at 60° C. (N) | 2.0 | 3.2 |

For identical wire structures and production and bonding processes, the wires B characterized by a thermo-adherent layer of TPU Estane X4995 had a pull-off temperature of 133° C. at 1.5 N, whereas the wire A with a thermo-adherent layer of polyamide PA had a pull-off temperature of 108° C. at 1.5 N (table 1). Thus the thermo-adherent layer made from polyurethane thermoplastic increased the pull-off temperature at 1.5 N by 23%.

Moreover, the wire B characterized by a thermo-adherent layer of TPU Estane X4995 had a pull-off force at a temperature of 60° C. equal to 3.2 N, whereas the wire A with a thermo-adherent layer of polyamide PA had a pull-off force equal to 2.0 N at the same temperature of 60° C. Thus the polyurethane thermoplastic thermo-adherent layer increased the pull-off force at 60° C. by approximately 37%.

Table 1 shows that using the thermo-adherent composition including a polyester type thermoplastic polyurethane, like that of sample B, improved cohesion at temperatures above 100° C., this improvement in cohesion being characterized by a greater resistance to pulling off at high temperature.

### Example II

Table 2 details the structure of eight new coil wire samples. Samples 1 to 4 are characterized in that their thermo-adherent layers are made from diverse polyamides. Samples 5 and 6 are noteworthy in that the thermo-adherent materials used are thermoplastic polyurethanes of the invention. Finally, samples 7 and 8 have thermo-adherent layers based on thermoplastic polyurethanes not conforming to the invention.

TABLE 2

| | Nature of | Diameter of | Bonding | Bonding |
|---|---|---|---|---|
| | thermo- | insulated | time | temperature |
| Sample | adherent layer | wire (mm) | (s) | (° C.) |
| 1 | PA11 | 0.37 | 30 s | 200° C. |
| 2 | PA Platamid | 0.37 | 30 s | 200° C. |
| 3 | PA 19690 | 0.335 | 30 s | 220° C. |
| 4 | PA 19670 | 0.335 | 30 s | 220° C. |
| 5 | TPU 4995 | 0.335 | 30 s | 220° C. |
| 6 | TPU 4890 | 0.335 | 30 s | 180° C. |
| 7 | TPU 1013 | 0.37 | 30 s | 200° C. |
| 8 | TPU 4990 | 0.37 | 30 s | 200° C. |

The sources of the various thermoplastic materials referred to in table 2 were as follows:
PA11 was a Rilsan polyamide 11 from Atofina.
PA Platamid was a Platamid aliphatic polyamide from Atofina.
PA 19690 was an Imidalbond 19690 aromatic polyamide from Nexans.
PA 19670 was an Imidalbond 19670 aromatic polyamide from Nexans.
TPU 4995 was a polyester type thermoplastic polyurethane from Noveon.
TPU 4890 was a polyester type thermoplastic polyurethane from Noveon.

TPU 1013 was a polyether type thermoplastic polyurethane from Noveon.
TPU 4990 was a polyether type thermoplastic polyurethane from Noveon.

To be able to compare the thermomechanical properties of the various thermo-adherent materials, tests analogous to those carried out in the context of example I were carried out. Table 3 groups together the main measurements effected and the single FIGURE of the appended drawing shows in more detail the behavior of each thermoplastic material.

TABLE 3

| | | | | | | | |
|---|---|---|---|---|---|---|---|
| Sample 1 | Temperature | 20 | 60 | 90 | 130 | 155 | — |
| | (° C.) | | | | | | |
| | Pull-off force | 247 | 208 | 178.5 | 175 | 150 | — |
| | (N) | | | | | | |
| Sample 2 | Temperature | 20 | 90 | 130 | 155 | — | — |
| | (° C.) | | | | | | |
| | Pull-off force | 247 | 138.3 | 77 | 34 | — | — |
| | (N) | | | | | | |
| Sample 3 | Temperature | 20 | 130 | 155 | 180 | — | — |
| | (° C.) | | | | | | |
| | Pull-off force | 229 | 173 | 133 | 59 | — | — |
| | (N) | | | | | | |
| Sample 4 | Temperature | 20 | 130 | 155 | 180 | — | — |
| | (° C.) | | | | | | |
| | Pull-off force | 226 | 151 | 82 | 22 | — | — |
| | (N) | | | | | | |
| Sample 5 | Temperature | 20 | 60 | 90 | 130 | 155 | 180 |
| | (° C.) | | | | | | |
| | Pull-off force | 368 | 300 | 259 | 64 | 36 | 30 |
| | (N) | | | | | | |
| Sample 6 | Temperature | 20 | 60 | 90 | 130 | 155 | 180 |
| | (° C.) | | | | | | |
| | Pull-off force | 322 | 232 | 165 | 105 | 57 | 44 |
| | (N) | | | | | | |
| Sample 7 | Temperature | 26 | 60 | 90 | 130 | 155 | 180 |
| | (° C.) | | | | | | |
| | Pull-off force | 94 | 81 | 70 | 31 | 24 | 23 |
| | (N) | | | | | | |
| Sample 8 | Temperature | 26 | 60 | 90 | 130 | 155 | 180 |
| | (° C.) | | | | | | |
| | Pull-off force | 91 | 82 | 71 | 29 | 26 | 16 |
| | (N) | | | | | | |

Table 3 shows that the compositions containing polyester type thermoplastic polyurethane (samples 5 and 6) had pull-off forces at temperatures from 20° C. to 90° C. higher than those of the polyamide type compositions (samples 1 to 4) and to those of compositions containing polyether type thermoplastic polyurethane (samples 7 and 8).

At 20° C., for example, the compositions containing polyester type thermoplastic polyurethane (samples 5 and 6) had pull-off forces 33 to 40% higher than those of samples 1 to 4 based on polyamide and 340% to 400% higher than those of samples 7 and 8 of polyether type thermoplastic polyurethane.

At 60° C., the compositions containing polyester type thermoplastic polyurethane (samples 5 and 6) had pull-off forces 30 to 50% higher than those of samples 1 and 2 based on polyamide and 73% higher than those of samples 7 and 8 using polyether type thermoplastic polyurethane.

At high temperatures, for example at temperatures around 180° C., the compositions containing polyester type thermoplastic type polyurethane (samples 5 and 6) had pull-off forces slightly less than or comparable to those of samples 3 and 4 based on polyamide but significantly higher than samples 7 and 8 based on polyether type thermoplastic polyurethane.

### Example III

The conservation modulus G′ was measured on two polyester type thermoplastic polyurethanes of the invention, namely TPU 4890 and TPU 4995, and on prior art polyether type thermoplastic polyurethanes, namely TPU 4990 and TPU 1013. The measurements were carried out at different characteristic temperatures, namely 25° C., 100° C. and 150° C. The results are grouped together in table 4 below.

TABLE 4

| Modulus of | G′ at 25° C. | G′ at 100° C. | G′ at 150° C. |
|---|---|---|---|
| conservation | (MPa) | (MPa) | (MPa) |
| TPU 4890 | 2018 | 342 | 104 |
| TPU 4995 | 1310 | 682 | 3 |
| TPU 4990 | 488 | 63 | 79 |
| TPU 1013 | 507 | 59 | 75 |

It is clear that the moduli of conservation of the polyester type thermoplastic polyurethanes (TPU 4890, TPU 4995) were significantly higher than those of the polyether type thermoplastic polyurethanes (TPU 4990, TPU 1013). This fully explains why the compositions of the invention offer better thermomechanical properties than prior art thermoplastic compositions.

In any event, the moduli of conservation of thermoplastic polyurethanes of the invention remain high over a wide range of temperatures, which advantageously corresponds to a standard range of operating temperatures for an electrical machine winding.

1. A thermo-adherent composition for coil wires comprising:
a polyester type thermoplastic polyurethane.

2. The thermo-adherent composition claimed in claim 1, wherein the modulus of conservation of said thermoplastic polyurethane is greater than 1 000 MPa at 25° C.

3. The thermo-adherent composition claimed in claim 1, wherein the modulus of conservation of said thermoplastic polyurethane is greater than 500 MPa at 100° C.

4. The thermo-adherent composition claimed in claim 1, wherein the modulus of conservation of said thermoplastic polyurethane is greater than 100 MPa at 150° C.

5. The thermo-adherent composition claimed in claim 1, wherein the bonding temperature of said thermoplastic polyurethane is from 150 to 250° C.

6. The thermo-adherent composition claimed in claim 1, wherein the viscosity of said thermoplastic polyurethane in the molten state is less than 100 Pa·s at 300° C.

7. The thermo-adherent composition claimed in claim 1, wherein said thermoplastic polyurethane has a crystalline phase.

8. The thermo-adherent composition claimed in claim 1, wherein said composition includes at least one inorganic charge.

9. The thermo-adherent composition claimed in claim 1, wherein said composition includes at least one other polymer.

10. A coil wire including a conductive element inside an insulative element covered by an external thermo-adherent layer, said thermo-adherent layer based on a thermo-adherent composition as claimed in claim 1.

11. The thermo-adherent composition claimed in claim 1, wherein the modulus of conservation of said thermoplastic polyurethane is greater than 2 000 MPa at 25° C.

12. The thermo-adherent composition claimed in claim 1, wherein the modulus of conservation of said thermoplastic polyurethane is greater than 1000 MPa at 100° C.

13. The thermo-adherent composition claimed in claim 1, wherein the modulus of conservation of said thermoplastic polyurethane is greater than 200 MPa at 150° C.

14. The thermo-adherent composition claimed in claim 1, wherein the bonding temperature of said thermoplastic polyurethane is from 150 to 200° C.

15. The thermo-adherent composition claimed in claim 1, wherein the viscosity of said thermoplastic polyurethane in the molten state is less than 1 Pa·s at 300° C.
